(19) United States
(12) Patent Application Publication
(10) Pub. No.: US 2023/0022567 A1
(43) Pub. Date: Jan. 26, 2023

(54) INTELLIGENT KNOWLEDGE PLATFORM

(71) Applicant: LinkedField Inc., Redwood City, CA (US)

(72) Inventors: KEVIN K. CHENG, Redwood City, CA (US); MIN HSIEH TSAI, Santa Clara, CA (US); MANISH DALIA, San Francisco, CA (US)

(73) Assignee: LinkedField Inc., Redwood City, CA (US)

(21) Appl. No.: 17/873,957

(22) Filed: Jul. 26, 2022

Related U.S. Application Data
(60) Provisional application No. 63/225,781, filed on Jul. 26, 2021.

(51) Int. Cl. G06N 5/02

(52) U.S. Cl. CPC G06N 5/022

(57) ABSTRACT

Apparatuses, methods, program products, and systems are disclosed for an intelligent knowledge platform. An apparatus includes a processor and a memory. The memory stores code executable by the processor to receive data associated with a project, the data describing one or more characteristics of the project; determine, using machine learning rules and algorithms, one or more metadata tags for the data for classifying the data; match the classified data to one or more predetermined knowledge insights for the project based on the metadata tags, the one or more predetermined knowledge insights stored in a knowledge database; and present, on a digital display device, the one or more predetermined knowledge insights.

### CROSS-REFERENCE TO OTHER APPLICATIONS

This application claims the benefit of U.S. Provisional Patent Application No. 63/225,781 entitled “INTELLIGENT KNOWLEDGE PLATFORM” and filed on Jul. 26, 2021, for Kevin K. Cheng, et al., which is incorporated herein by reference.

### FIELD

This invention relates to knowledge management and more particularly relates to an intelligent knowledge platform.

### BACKGROUND

In many industries, there is a significant knowledge gap between what is taught in schools and the practical know-how learned on the job. For some jobs, this gap can lead to mistakes and even accidents, such as jobs in construction, manufacturing, or that otherwise involve potentially dangerous tools or machinery.

### BRIEF SUMMARY

Apparatuses, methods, program products, and systems are disclosed for an intelligent knowledge platform. In one embodiment, an apparatus includes a processor and a memory. The memory, in one embodiment, stores code executable by the processor to receive data associated with a project, the data describing one or more characteristics of the project; determine, using machine learning rules and algorithms, one or more metadata tags for the data for classifying the data; match the classified data to one or more predetermined knowledge insights for the project based on the metadata tags, the one or more predetermined knowledge insights stored in a knowledge database; and present, on a digital display device, the one or more predetermined knowledge insights.

In one embodiment, the project comprises a construction project composed of a plurality of tasks, the data describing each task of the plurality of tasks such that the tasks are classified according to the metadata and associated with the one or more knowledge insights.

In one embodiment, the code is executable by the processor to predict, using the machine learning rules and algorithms, one or more future conditions of the project based on a state of one or more tasks of the project.

In one embodiment, the code is executable by the processor to identify knowledge insights of the one or more predetermined knowledge insights associated with the predicted one or more future conditions to present based on the state of the one or more tasks of the project.

In one embodiment, the one or more knowledge insights comprise information related to one or more of common mistakes, training materials, lessons learned, definitions, procedures, manuals, or a combination thereof.

In one embodiment, the one or more knowledge insights comprise explanations, schematics, diagrams, blueprints, instructional multimedia, associated codes and laws, or a combination thereof.

In one embodiment, the one or more tasks of the project are associated with one or more users that are engaged to complete the one or more tasks.

In one embodiment, the code is executable by the processor to predict the one or more future conditions of the project and present the corresponding knowledge insights for the one or more future conditions in response to the one or more users signing in to work on the project.

In one embodiment, the code is executable by the processor to present an interface for receiving user log in information from the one or more users and create a contact list for the project for tracking the one or more users that are working on the project.

In one embodiment, the code is executable by the processor to periodically push knowledge insight information to the one or more users based on a status of the one or more tasks that the one or more users are in the process of completing.

In one embodiment, the code is executable by the processor to assign knowledge insight information to one or more users in response to input from a manager and push the knowledge insight information to the one or more assigned users.

In one embodiment, the code is executable by the processor to receive external information for the knowledge database, the external information comprising experiential survey data received from one or more project managers, information scraped from one or more online resources, and information derived from one or more documents.

In one embodiment, the code is executable by the processor to generate a plan and schedule for the project based on the details of the project and the knowledge insights in the knowledge database.

In one embodiment, the code is executable by the processor to receive information for a change order for the project, the information describing one or more characteristics of the change order.

In one embodiment, the code is executable by the processor to determine a phase of the change order, whether the change order is outsourceable, and skills required to complete the change order.

In one embodiment, the code is executable by the processor to generate one or more recommendations for completing the change order, the one or more recommendations based on knowledge insights generated for the change order.

In one embodiment, in response to the change order being outsourceable, the one or more recommendations comprise a recommendation for one or more professionals that have skills matching the skills required to complete the change order.

In one embodiment, the code is executable by the processor to determine metadata tags for the change order information and add the change order information to the knowledge database for generating one or more knowledge insights in response to the knowledge database not comprising the change order information.

A method, in one embodiment, includes receiving data associated with a project, the data describing one or more characteristics of the project; determining, using machine learning rules and algorithms, one or more metadata tags for the data for classifying the data; matching the classified data to one or more predetermined knowledge insights for the project based on the metadata tags, the one or more predetermined knowledge insights stored in a knowledge database; and presenting, on a digital display device, the one or more predetermined knowledge insights.

An apparatus, in one embodiment, includes means for receiving data associated with a project, the data describing one or more characteristics of the project; means for determining, using machine learning rules and algorithms, one or more metadata tags for the data for classifying the data; means for matching the classified data to one or more predetermined knowledge insights for the project based on the metadata tags, the one or more predetermined knowledge insights stored in a knowledge database; and means for presenting, on a digital display device, the one or more predetermined knowledge insights.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for a knowledge platform;

FIG. 2 is a schematic block diagram illustrating one embodiment of an apparatus for a knowledge platform;

FIG. 3 is a schematic block diagram illustrating one embodiment of another apparatus for a knowledge platform;

FIG. 4 is a schematic flow chart diagram illustrating one embodiment of a method for a knowledge platform; and

FIG. 5 is a schematic flow chart diagram illustrating one embodiment of another method for a knowledge platform.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to emphasize their implementation independence more particularly. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider). In some embodiments, electronic circuitry including, for example, programmable logic circuitry, field-programmable gate arrays (“FPGA”), or programmable logic arrays (“PLA”) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatuses, systems, and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

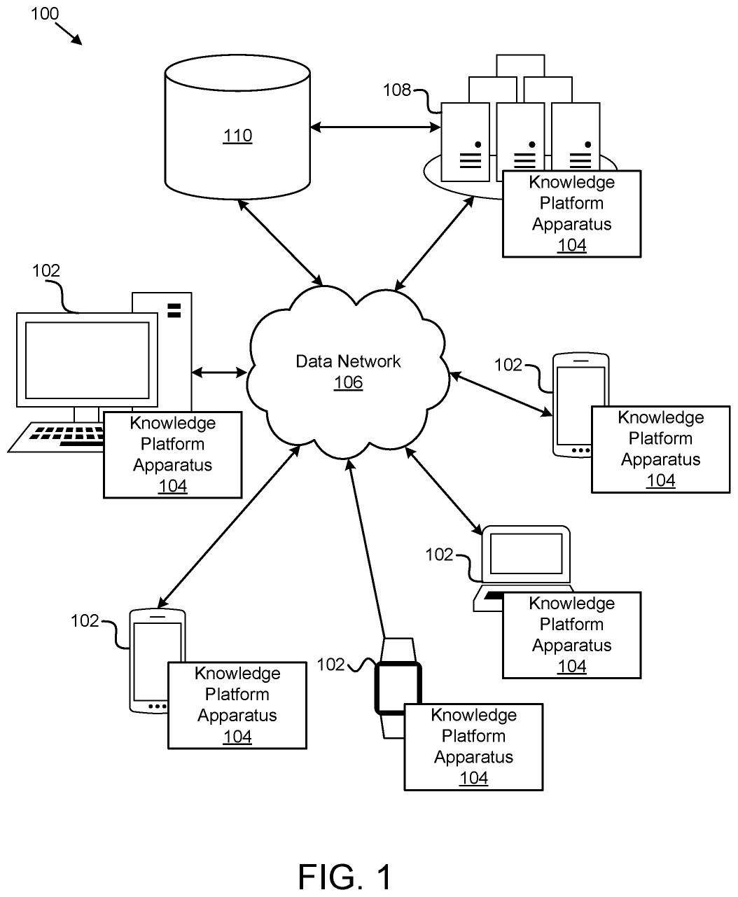

FIG. 1 is a schematic block diagram illustrating one embodiment of a system 100 for a knowledge platform. In one embodiment, the system 100 includes one or more computing devices 102, one or more knowledge platform apparatuses 104, one or more data networks 106, one or more servers 108, and one or more knowledge databases 110. In certain embodiments, even though a specific number of computing devices 102, knowledge platform apparatuses 104, data networks 106, servers 108, and/or knowledge databases 110 are depicted in FIG. 1, one of skill in the art will recognize, in light of this disclosure, that any number of computing devices 102, knowledge platform apparatuses 104, data networks 106, servers 108, and/or knowledge databases 110 may be included in the system 100.

In one embodiment, the system 100 includes one or more computing devices 102. A computing device 102 may be embodied as one or more of a desktop computer, a laptop computer, a tablet computer, a smart phone, a smart speaker (e.g., Amazon Echo®, Google Home®, Apple HomePod®), an Internet of Things device, a security system, a set-top box, a gaming console, a smart TV, a smart watch, a fitness band or other wearable activity tracking device, an optical head-mounted display (e.g., a virtual reality headset, an augmented reality headset, smart glasses, headphones, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium, a display, a connection to a display, or the like.

In general, in various embodiments, a knowledge platform apparatus 104 is configured to provide insights and/or other data for one or more users based on machine learning/artificial intelligence using data from a knowledge database 110. For example, a knowledge platform apparatus 104 may generate insights, recommendations, suggestions, and/or other information (e.g., practical know-how) for new employees, workers, and/or other users (e.g., in a particular industry, such as construction, manufacturing, or the like). In this manner, in one embodiment, a knowledge platform apparatus 104 bridges a gap between traditional school education and practical know how usually learned “on the job” or through many years of experience.

A knowledge platform apparatus 104 may be configured to provide workforce management for one or more teams (e.g., construction project teams, manufacturing teams, shifts, departments, or the like). A knowledge platform apparatus 104 may provide knowledge and/or other training to team members or other users, such as team members of a general contractor, to professional engineers, or the like (e.g., in order for the team members to successfully manage scopes of work in projects, to overcome blockers and/or blind spots in the work, to learn certain on the job training before making mistakes, to make them aware of what is coming up next, to make them aware of one or more critical tasks and/or dependencies to attend to, in the context of a specific project phase, in the context of a scope of work a team member manages, or the like).

For instance, as described in more detail below, the knowledge platform apparatus 104 may predict the time frame, e.g., a day or week, that a particular project phase or schedule will occur (e.g., when wall framing will start or when flooring is going to be installed). When something in the real world changes or schedule shifts, the knowledge platform apparatus 104 may accurately predict the new day or week that the subsequent project phase/schedule will occur. Based on knowing when a particular task will occur (e.g., either on the day or the week), the knowledge platform apparatus 104 can deploy the right knowledge to the project team members, e.g., project managers, subcontractors, employees, support staff, or the like.

In various embodiments, a knowledge platform apparatus 104 may provide a training marketplace, a democratized knowledge community, a “project GPS” that offers step-by-step insights and/or keeps multiple users aligned on a project, or the like. A knowledge platform apparatus 104 may provide insights (e.g., construction insights, or the like) and may comprise a guiding information architecture that allows project members or other users to access the insights in the right way and/or at the right time, to improve their work, or the like. A knowledge platform apparatus 104 may cover one or more phases of a project, job, and/or scope of work (e.g., actionable insights and/or other knowledge to push work forward).

A knowledge platform apparatus 104 may include knowledge determined based on a “diary study” or the like with experienced workers or other users in the industry, which prompts them with periodic (e.g., daily) questions to answer (e.g., about difficulties they've encountered in their current job, how they resolved those issues, or the like). In a further embodiment, a knowledge platform apparatus 104 may include knowledge determined based on a set of interviews with project managers, experienced workers, and/or other users, to understand knowledge gaps from their perspective, to identify specific scopes that are notable and/or of interest, to determine specific areas of knowledge, to determine existing pathways for attempting to resolve problems that arise on the job, or the like.

A knowledge platform apparatus 104, in one embodiment, pushes knowledge to users periodically. In a further embodiment, a knowledge platform apparatus 104 comprises a lookup system where users can lookup specific lessons or other knowledge. A knowledge platform apparatus 104 may deliver valuable insights to project members and/or other users to help them understand their work in-context. A knowledge platform apparatus 104 may provide users weekly or other periodic assignments, learning, and/or task templates based upon the specific needs of their current project, or the like. A knowledge platform apparatus 104 may organize knowledge into lessons or other curriculum, and/or provide up-front knowledge delivery that allows a user working on a project to immediately access knowledge relevant to their phase and scope, or the like.

A knowledge platform apparatus 104, in some embodiments, captures useful knowledge from veteran workers with practical job knowledge before or as they are leaving the industry, for sharing with and training new workers. For example, a knowledge platform apparatus 104 may prompt a veteran worker with one or more simple questions. In this manner, a knowledge platform apparatus 104 may seed a knowledge database that may generate highly valuable insights aligned to project phase, scope, and/or region (e.g., that would otherwise be locked away in isolated forums, forgotten binders, and/or other workers who are already very busy).

A knowledge platform apparatus 104 may capture knowledge from one or more project managers (e.g., in a preconstruction stage, a planning stage, or the like), from one or more planning systems, from one or more documents, from one or more conversations, or the like. Based on collected knowledge, a knowledge platform apparatus 104 may help project managers and/or other users to predict important events in advance, send reminders and/or tasks to a team, prompt users to uphold better project practices (e.g., scope-specific retros, insight logging, or the like). A knowledge platform apparatus 104 may automate its guidance to provide automated project scheduling (e.g., providing a project manager or other user a series of questions, providing a plan, proposing variations, or the like).

A knowledge platform apparatus 104, in some embodiments, may offer a variety of integrations (e.g., to coordinate with systems of record while providing a view of the project for a project manager and/or team to understand where they are and where they have to go next, or the like). In one embodiment, a knowledge platform apparatus 104 provides knowledge and/or insights to a preliminary team (e.g., to prepare a project, to load a project, to pass off a project, or the like). A knowledge platform apparatus 104 may allow others in an industry to add their knowledge, which may increase potential customer reach, as specialized providers and/or vendors create and/or sell knowledge and training for specialized roles, equipment, or the like which may not be suitable for the general public.

A knowledge platform apparatus 104, in certain embodiments, may monitor trainings and may sense or otherwise determine trends (e.g., where the future of construction knowledge will be, or the like). For example, content of a knowledge platform apparatus 104 may cover the scope of construction activities, or activities in another industry, and may determine where users are spending increased time, allowing older training and/or knowledge to become irrelevant, or the like.

For companies with existing training material, in some embodiments, a knowledge platform apparatus 104 may realign knowledge delivery of the existing corporate material into a new scope and/or schedule, thereby activating existing content in a timely, actionable manner. A knowledge platform apparatus 104 may deliver knowledge to employees or other users based on where they are in their projects, while also cumulatively tracking employee training and/or upskilling throughout their career, across multiple projects, or the like.

A knowledge platform apparatus 104, in one embodiment, may collect images from users. For example, a knowledge platform apparatus 104 may ask users to provide screenshots of what they are doing in order to collect knowledge from them for training others. A knowledge platform apparatus 104 may mix up or shuffle diary questions to keep things interesting and motivate the participants, or the like. A knowledge platform apparatus 104, instead of responding to a diary study every day, every other day, or the like may prompt a participant to send something whenever a certain event happens (e.g., take a screenshot when [this event] happens, or the like). In a further embodiment, a knowledge platform apparatus 104 may prompt a participant to record themself giving a summary of their day (e.g., a 5 minute summary, a 2 minute summary, a 1 minute summary, or the like).

A knowledge platform apparatus 104, in some embodiments, may track users' connections, may suggest mutual connections based on a user's personal phone contacts, the people they and their co-workers worked with, or the like. In a further embodiment, a knowledge platform apparatus 104 may auto-build detailed work experiences and/or profiles for users. For example, if a user interacted with mechanical, electrical, and plumbing subcontracts 80% of the time, a knowledge platform apparatus 104 may include them in a work experience profile for the user, or the like.

In one embodiment, a knowledge platform apparatus 104 may determine and provide one or more project insights. For example, a knowledge platform apparatus 104 may use actual worker mobilization data (e.g., a safety sign-in, or the like) to predict the project phase and/or schedule and in turn predict the right project insight and/or action to suggest to a team member. A knowledge platform apparatus 104 may provide an interface for users to tag these suggested actions as completed or missed to help a company understand areas of improvement, or the like. A knowledge platform apparatus 104 may determine lessons-learned from each project so the same mistakes are not made across all their other projects, or the like.

A knowledge platform apparatus 104, in some embodiments, may suggest a targeted list of skills for endorsement and/or ratings by peers, supervisors, or the like for different user types and/or roles. A knowledge platform apparatus 104 may match construction vendors (e.g., equipment, material suppliers, or the like) to a project based on vicinity, type of construction, phase, size of construction, or the like. A knowledge platform apparatus 104, in some embodiments, may suggest equipment and/or tools to subcontractor stakeholders from participating nearby vendors, providing the vendors with access to project stakeholders at the right time and providing project stakeholders with a fast and easy way to get supplies and equipment when needed without wasting time researching.

A knowledge platform apparatus 104 may be configured to auto-score a management experience level for each construction trade (e.g., structural, flooring, electric, glazing, or the like) for project stakeholders (e.g., subcontractors, general contractors, foremen, project managers, professional engineers, superintendents, or the like). A knowledge platform apparatus 104 may provide the determined score to users in order for the users to find qualified personnel to hire, or the like.

A knowledge platform apparatus 104, in one embodiment, may suggest new certifications and/or licenses for workers, may reminders workers of renewal deadlines for existing certifications and/or licenses, or the like. A knowledge platform apparatus 104 may use safety sign-in data to auto-assist teams in updating project schedules based on actual workforce mobilization and/or utilization, or the like. In certain embodiments, a knowledge platform apparatus 104 may display project manpower status, suggest targeted manpower adjustments, or the like.

In some embodiments, a knowledge platform apparatus 104 may suggest one or more new hires based on project needs (e.g., skill shortages for a project), direct them to a hiring platform, and/or use the results of that hiring as feedback for subsequent hiring suggestions, or the like. A knowledge platform apparatus 104 may help companies to understand their workforce, using data to build a worker's career work experience and/or skills to create profiles in minutes. A knowledge platform apparatus 104 may be configured to collect this data from accounting systems, timecards, user notes/reports, safety reports, or the like.

In one embodiment, the knowledge platform apparatus 104 is configured to receive data associated with a project, the data describing one or more characteristics of the project, determine, using machine learning rules and algorithms, one or more metadata tags for the data for classifying the data, match the classified data to one or more predetermined knowledge insights for the project based on the metadata tags, and present, on a digital display device, the one or more predetermined knowledge insights. In certain embodiments, the knowledge platform apparatus 104 is in communication with a knowledge database that stores data for deriving knowledge insights, knowledge insights, training data or other data that the machine learning uses to generate a machine learning model, and/or the like.

In certain embodiments, the knowledge platform apparatus 104 may include a hardware device such as a secure hardware dongle or other hardware appliance device (e.g., a set-top box, a network appliance, or the like) that attaches to a device such as a head mounted display, a laptop computer, a server 108, a tablet computer, a smart phone, a security system, a network router or switch, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); or the like. A hardware appliance of the knowledge platform apparatus 104 may include a power interface, a wired and/or wireless network interface, a graphical interface that attaches to a display, and/or a semiconductor integrated circuit device as described below, configured to perform the functions described herein with regard to the knowledge platform apparatus 104.

The knowledge platform apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the knowledge platform apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the knowledge platform apparatus 104.

The semiconductor integrated circuit device or other hardware appliance of the knowledge platform apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the knowledge platform apparatus 104 includes and/or is communicatively coupled to one or more non-volatile memory media, which may include but is not limited to: NAND flash memory, NOR flash memory, nano random access memory (nano RAM or “NRAM”), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, or the like. The data network 106 may include a wide area network (“WAN”), a storage area network (“SAN”), a local area network (“LAN”) (e.g., a home network), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The one or more servers 108, in one embodiment, may be embodied as blade servers, mainframe servers, tower servers, rack servers, or the like. Functionally, the one or more servers 108 may be configured as mail servers, web servers, application servers, FTP servers, media servers, data servers, web servers, file servers, virtual servers, or the like. The one or more servers 108 may be communicatively coupled (e.g., networked) over a data network 106 to one or more computing devices 102.

In one embodiment, the computing device 102 is communicatively coupled to one or more devices or servers 108 over a data network 106. More particularly, the knowledge platform apparatus 104 executing on the computing device 102 may be communicatively coupled to or in communication with the knowledge platform apparatus 104 executing on the server 108.

In one embodiment, the knowledge database 110 may be embodied as a storage device on a cloud server, in a data center, as local storage, as a network attached storage, and/or the like. The knowledge database 110 may be configured as a relational database, an object-oriented database, a NoSQL database, and/or the like. The knowledge database 110 may be directly connected to the one or more servers 108 or may be accessible via the data network 106.

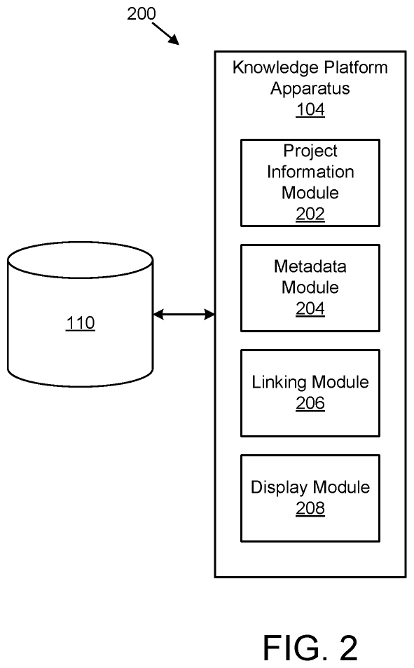

FIG. 2 depicts one embodiment of an apparatus 200 for an intelligent knowledge platform. In one embodiment, the apparatus 200 includes an embodiment of a knowledge platform apparatus 104. In one embodiment, the knowledge platform apparatus 104 includes one or more of a project information module 202, a metadata module 204, a linking module 206, and a display module 208, which are described in more detail below.

In one embodiment, the project information module 202 is configured to receive data associated with a project. As used herein, a project may refer to a planned or designed undertaking. In certain embodiment, the project may be comprised of a number of tasks, phases, sub-projects, and/or the like that need to be completed to complete the project. The tasks may be sequential such that a first task needs to be completed before a second task can commence.

For example, the project may include a construction project composed of a plurality of tasks or phases such as excavating, laying the foundation, framing, roofing, plumbing, electrical work, hanging drywall, other finish work, and/or the like. For simplicity, the subject matter herein may be described with reference to construction projects, but one or skill in the art will recognize, in light of this disclosure, the applicability of the claimed solution to other projects such as software development, event planning, or the like.

In one embodiment, the data that the project information module 202 receives describes one or more characteristics of the project. The one or more characteristics may include a project name, location, address, type, commencement date, target completion date, project phase(s) and/or schedule, project budget, materials to be used, project managers, sub-contractors to be used, and/or the like.

In certain embodiments, the one or more tasks or phases of the project are associated with one or more users that are engaged to complete the one or more tasks, e.g., employees, sub-contractors, project managers, project engineers, and/or the like. As explained below, the knowledge platform apparatus 104 tracks users that log in to the system and provide the users with insights regarding the tasks/phases of the project. For instance, the one or more knowledge insights may include information related to common mistakes, training materials, lessons learned, definitions, procedures, manuals, or a combination thereof. Furthermore, the one or more knowledge insights comprise explanations, schematics, diagrams, blueprints, instructional multimedia, associated codes and laws, or a combination thereof. The knowledge insights may be based on the knowledge database 110 and may be curated, generated, identified, or the like for the user and/or the phase of the project using machine learning.

Machine learning, as used herein, may refer to a type of artificial intelligence that allows computers and software to become more accurate, over time, at predicting outcomes without being explicitly programmed to do so. Machine learning algorithms may be trained using historical training data to generate a specialized, customized machine learning model for use in predicting, estimating, forecasting, or the like, outcomes based on new input data, e.g., new project data for a construction project, as described in more detail below. Periodically, the machine learning model may be refined or retrained based on new information or training data, e.g., new project or task data, new employee data, new third party outsourcing data, and/or the like.

In one embodiment, the metadata module 204 is configured to determine, using the machine learning rules and algorithms, one or more metadata tags for the data for classifying the data. In one embodiment, the project information that the project information module 202 receives may be input to a machine learning model, or multiple machine learning models, which have been trained on historical information related to the project. For instance, the project may be construction of a new home and the metadata module 204 may dynamically determine a machine learning model to use or implement that has been trained on similar, historical project information. For example, the metadata module 204 may cross-reference the received project information with project information associated with machine learning models to identify a machine learning model that has been trained and specially configured to process similar project information.

In one embodiment, the metadata module 204 provides the received project information to the selected machine learning model to generate, identify, create, or the like metadata tags for the project information that corresponds to metadata tags for insights in the knowledge database 110. For instance, the received project information may include data describing each task of the plurality of tasks such that the tasks are classified according to the metadata and associated with the one or more knowledge insights in the knowledge database 110.

The linking module 206, for instance, is configured to match the classified data to one or more predetermined knowledge insights for the project based on the metadata tags. For example, each task or phase of a project may be assigned a metadata tag that the machine learning generates or identifies and that corresponds to one or more resources within the knowledge database 110 such as inspections to be completed, mistakes to avoid, schematics, blueprints, audio/video resources, diagrams, explanations, tips, recommendations, suggestions, or other educational insights for the particular task, for predicted tasks (explained below), and/or the like such that as the project commences, knowledge insights may be presented, pushed, sent, or the like to the user/users working on the project tasks based on the cross-referenced metadata tags between the project information and the insights in the knowledge database 110.

In this manner, an administrator or other user does not need to manually determine and assign each of the metadata tags to the project information and link or match the classified project information, based on the metadata tags, to insight information in the knowledge database 110, which would take an impractical amount of time and effort to maintain and manage as the knowledge database 110 dynamically grows and changes based on the new information being added, existing information being changed, old information being removed, and/or the like.

In one embodiment, the display module 208 is configured to present, on a digital display device, the one or more predetermined knowledge insights. For example, when a user commences a task, e.g., selects a task to be worked on and completed from a user interface, the display module 208 may receive, access, or the like one or more knowledge insights for the task, based on the metadata for the selected task, and present the knowledge insights on the electronic display of the user's device, e.g., smart phone display. The knowledge insights may include an audio explanation of the tasks, a list of steps to or checklist to go through to complete the task, a video showing how to complete the same or similar task, and/or the like.

In this manner, the knowledge platform apparatus 104 may generate insights, recommendations, suggestions, and/or other information (e.g., practical know-how) for new employees, workers, and/or other users (e.g., in a particular industry, such as construction, manufacturing, or the like). The knowledge platform apparatus 104 bridges the gap between traditional school education or other non-hands-on training and practical know-how usually learned “on the job” or through many years of experience.

Furthermore, the knowledge platform apparatus 104 improves indexing and efficiently accessing data in the knowledge database 110 using machine learning to dynamically generate metadata tags for project information and link the generated metadata tags to the knowledge insights in the knowledge database 110.

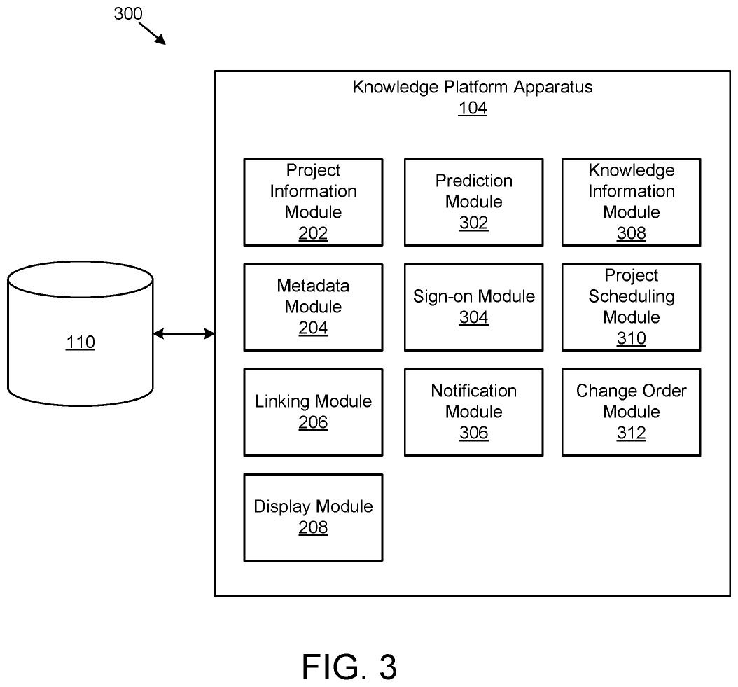

FIG. 3 depicts one embodiment of an apparatus 300 for an intelligent knowledge platform. In one embodiment, the apparatus 300 includes an embodiment of a knowledge platform apparatus 104. In one embodiment, the knowledge platform apparatus 104 includes one or more of a project information module 202, a metadata module 204, a linking module 206, and a display module 208, which may be substantially similar to the project information module 202, the metadata module 204, the linking module 206, and the display module 208 described above with reference to FIG. 2. In further embodiments, the knowledge platform apparatus includes one or more of a prediction module 302, a sing-on module 304, a notification module 306, a knowledge information module 308, a project scheduling module 310, and a change order module 312, which are described in more detail below.

In one embodiment, the prediction module 302 is configured to predict, using the machine learning rules and algorithms, one or more future conditions of the project based on a state of one or more tasks of the project. The prediction module 302, for instance, may input the current state of the task or phase of the project that is being completed, e.g., using a task/phase identifier, or the like, which the prediction module 302 may input to the machine learning to predict various future conditions of the project that may occur responsive to the task being completed. The current state may comprise a flag or other indicator that indicates that the task/phase is a certain percentage completed, is complete, is just beginning, has not be started yet, is suspended pending completion of another task/phase, and/or the like.

The future conditions may include the next steps, other tasks that may need to be completed before moving on to the next steps, potential problems to foresee/expect, materials or personnel needed to complete the next steps, or the like. In such an embodiment, the machine learning may output various metadata tags that may be used to reference the knowledge database 110 to determine knowledge insights associated with the completed task of the project. For example, on a home construction project, if the prediction module 302 determines or is notified that the rough electrical, plumbing, HVAC (heating, ventilation, and air conditioning), and framing has been completed, it may determine that the next step is a four-way inspection and may identify, using the machine learning model (e.g., inputting that a four-way inspection for this particular project is due), knowledge insights to prepare project managers and workers that the four-way inspection is due by a certain date, what needs to be prepared for the four-way inspection, some common mistakes or issues with similar four-way inspections, and/or the like. Furthermore, the prediction module 302 may proactively, with or without a user's confirmation, schedule an inspector for the four-way inspection, e.g., by sending an email or other notification to an inspector (if known) or to an inspection company/agency.

In another example, the prediction module 302 may predict that the framing task/phase is next in response to input from a metal studs foreman. Based on the prediction, the prediction module 302 may identify one or more insights for the next task/phase, using the machine learning, which may include verifying priority walls, checking MEP conflicts, and/or the like. In a similar example, the prediction module 302 may predict that the drywall task/phase is next in response to input from a drywall foreman or crew. Based on the prediction, the prediction module 302 may identify one or more insights for the next task/phase, using the machine learning, which may include verifying frame throat size, checking wall backing, and/or the like. Thus, in these examples, the prediction module 302 is triggered in response to some input from a user associated with a task. The prediction module 302 may also be triggered in response to a setting, value, flag, or other indicator associated with the commencement or completion of a phase/task.

In one embodiment, the prediction module 302 may predict the one or more future conditions of the project and present the corresponding knowledge insights for the one or more future conditions in response to the one or more users signing in to work on the project. As explained in more detail below, users working on the project, such as employees, managers, engineers, administrators, support staff, and/or the like, may digitally sign in, check in, register, and/or the like as a user working on the project, or more specifically, a task or phase of the project, which may then trigger the prediction module 302 to generate, identify, or otherwise access knowledge insights for the user based on the current state of the task or phase, which are then presented to the user in response to the user signing in.

In such an embodiment, the prediction module 302 triggers accessing, receiving, or determining knowledge insights using metadata tags, generated using the machine learning model, for a project phase or schedule based on predicting the project phase or schedule for the project. The prediction module 302 predicts the project phase or schedule by capturing and aggregating types of workers, e.g., drywall workers, painters, plumbers, electricians, or the like, that arrive and sign-on to the project via the sign-on module 304 below. For instance, if plumbers and electricians sign-on to work on the project, the prediction module 302 may input the information into the machine learning model, to create metadata tags associated with the input data, e.g., plumber, electrician, plumbing, electrical, or the like, which may signal that that the rough plumbing and electrical work is being worked on. Accordingly, the metadata tags may be used to identify, query, access, or the like the insights in the knowledge database for the predicted project and present the insights to the plumbers and electricians that are working on the project.

In one embodiment, the sign-on module 304 is configured to present an interface for receiving user log in information from the one or more users. The sign-on interface may display a form for entering unique electronic credentials, biometric credentials, and/or the like. If a user is a new user in the system, the sign-on module 304 may present a form for registering the user, which may include fields for entering contact information and verifying licensing and/or insurance credentials prior to authorizing the user.

The sign-on module 304 may create and maintain a contact list for the project for tracking the one or more users that are working on the project. In such an embodiment, an administrator or manager, or someone with similar credentials, may view the users that are working on the project and the current state of the tasks or phases that are being completed to determine whether the users are working efficiently, whether the users are the right workers for a particular task/phase, whether the project budget is being met, and/or whether the project is on track to be completed according to a predetermined project schedule, described below.

In one embodiment, the notification module 306 is configured to periodically push knowledge insight information to the one or more users based on a status of the one or more tasks that the one or more users are in the process of completing. For instance, the notification module 306 may push knowledge insights to workers on a daily basis in response to the prediction module 302 determining or forecasting what the workers' expected duties are for the day for their particular tasks. The notification module 306 may push notifications on a weekly basis, a monthly basis, on an as-needed basis (e.g., as certain tasks are completed or if a complex task is being completed), and/or the like.

In one embodiment, the notification module 306 may send knowledge insights based on the type of employee or personnel working on the project. For instance, a new employee may get daily insights to help train the new employee. Whereas a middle-manager may receive weekly insights, including reports on what others on their team are working on and the insights that they are receiving. A project manager may receive daily summaries and a weekly report that is generated based on the tracking information from the sign-on module 304, the insight information from the knowledge database, and the tracked progress of the project based on feedback from the employees, e.g., checking tasks off as they are completed, moving onto the next phase in the project, or the like.

In one embodiment, the notification module 306 assigns knowledge insight information to one or more users in response to input from a manager and push the knowledge insight information to the one or more assigned users. For example, a manger may want to send a new employee additional information about a particular task and may provide the notification module 306 with the type of information that they want to send to the new employee. The notification module 306 may take the new information and feed it into a machine learning model for the project to determine the knowledge insights from the knowledge database to push to the new employee, e.g., via a mobile application, via a text message, via a social media post, via an email, and/or the like.

In one embodiment, the knowledge information module 308 is configured to receive external information for the knowledge database, the external information comprising experiential survey data received from one or more project managers, information scraped from one or more online resources, and information derived from one or more documents.

For instance, in one embodiment, the knowledge information module 308 may present surveys to project managers with questions such as “What are two common mistakes you noticed in your career?,” “What are two things that you would tell new employees?,” and/or the like. The knowledge information module 308 may search other sources for information such as online resources, e.g., message boards, video sharing sites (e.g., YouTube®), and/or the like; government agency websites; company websites; social media networks; uploaded documents (e.g., project plans, code manuals, government regulations, blueprints, schematics, and/or the like); and/or the like.

In one embodiment, the knowledge information module 308 feeds the information to the machine learning model to generate metadata tags for the information for indexing or classifying the information in the knowledge database 110, where it can later be cross-referenced and accessed as knowledge insights associated with a project.

In one embodiment, the project scheduling module 310 is configured to generate a plan and schedule for the project based on the details of the project and the knowledge insights in the knowledge database. For instance, the knowledge database may include timeline or time frame information for various projects, various stages or phases of different projects, sub-contractor lead time, supply chain lead time, and/or the like. Based on the project information provided to the machine learning model, the project scheduling module 310 may receive time-related information from the knowledge database 110 and may compose, estimate, or determine an initial project schedule, including when certain tasks/phases should commence/finish, based on the knowledge information. The project scheduling module 310 may periodically update the project schedule, using current project progress information provided to the machine learning model, during completion of the project.

In one embodiment, the change order module 312 is configured to receive information for a change order for the project. In one embodiment, the information includes one or more characteristics of the change order. As used herein, a change order may refer to an amendment to a construction contract (or other similar type of contract for a project) that changes the scope of work. Thus, in a home construction scenario, a change order may be related to a change to the plans or blueprints for the home design, or the like. Thus, the change order information may include the type of change, the estimated cost of the change, the estimated time to implement the change, the subcontractors/trades involved, and/or the like.

In one embodiment, the change order module 312 determines a phase of the change order (e.g., a collect phase or a review phase), whether the change order is outsourceable (e.g., can be completed by a third-party), and skills required to complete the change order (e.g., mechanical, electrical, concrete, post-tensioned reinforcement, related to a utility company's jurisdiction, and/or the like).

In one embodiment, the change order module 312 generates one or more recommendations for completing the change order, using the machine learning model and the knowledge insights in the knowledge database 110. For example, the change order module 312 may input the change order details into the machine learning model (which may be trained on historical change order data), to determine or generate metadata tags corresponding to recommendations or other insights in the knowledge database 110.

For instance, in one embodiment, in response to the change order being outsourceable, the one or more recommendations may include a recommendation for one or more professionals that have skills matching the skills required to complete the change order. In such an embodiment, the information for the professionals may be stored in the knowledge database 110 as part of a subcontractor table, a professionals table, and/or the like.

In one embodiment, the change order module 312 determines metadata tags for the change order information, using the machine learning, and adds the change order information to the knowledge database 110, indexed or classified by the determined metadata tags, for generating one or more knowledge insights in response to the change order information not being included in the knowledge database 110.

In one embodiment, the change order module 312 may automatically, without user input or intervention, determine which professionals to contact to complete the change order, if the change order is outsourceable, based on the machine learning and the information in the knowledge database 110, and may contact the determined professions, e.g., via text, email, automated phone message, social media, a webform, and/or the like. In this manner, the knowledge platform apparatus 104 can proactively take actions without the user input, and the user may feel confident that the automated actions are accurate due to the accuracy of the machine learning model and the information in the knowledge database 110.

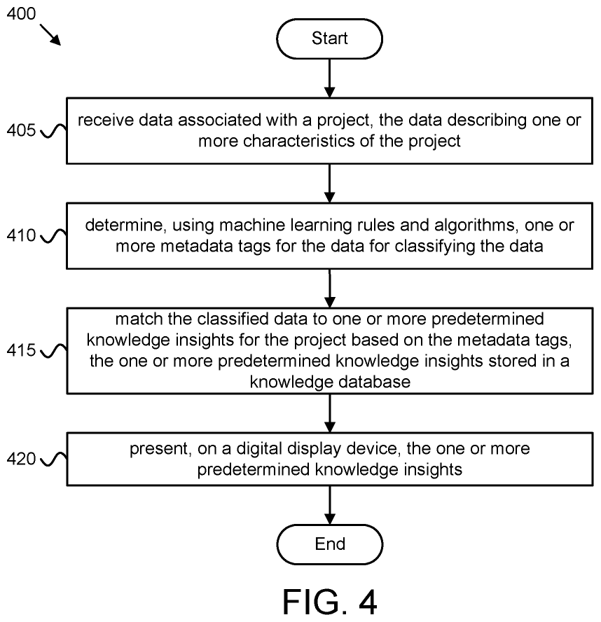

FIG. 4 depicts one embodiment of a method 400 for an intelligent knowledge platform. In one embodiment, the method 400 begins and receives 405 data associated with a project, the data describing one or more characteristics of the project. In one embodiment, the method 400 determines 410, using machine learning rules and algorithms, one or more metadata tags for the data for classifying the data. In one embodiment, the method 400 matches 415 the classified data to one or more predetermined knowledge insights for the project based on the metadata tags, the one or more predetermined knowledge insights stored in a knowledge database. In one embodiment, the method 400 presents 420, on a digital display device, the one or more predetermined knowledge insights, and the method 400 ends. In one embodiment, the method 400 may be performed by a knowledge platform apparatus 104, a project information module 202, a metadata module 204, a linking module 206, and/or a display module 208.

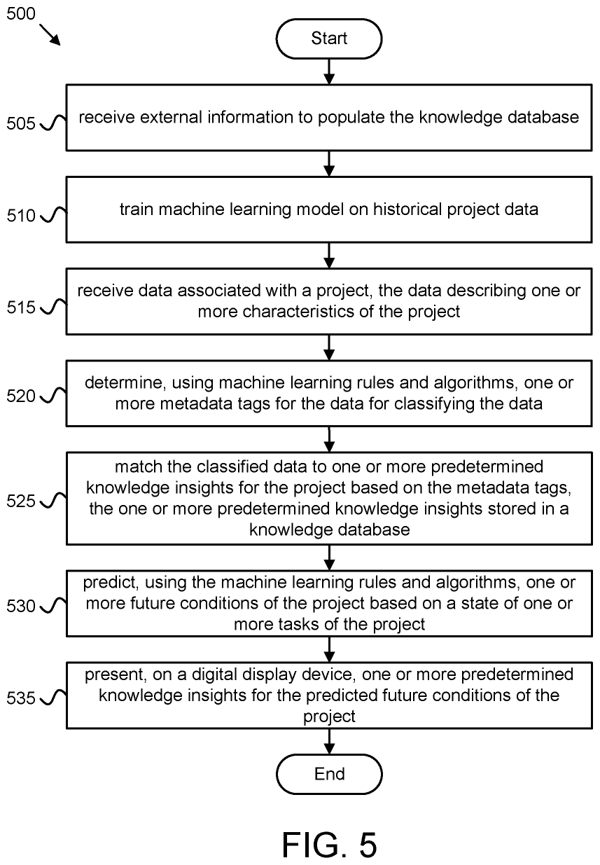

FIG. 5 depicts one embodiment of a method 500 for an intelligent knowledge platform. In one embodiment, the method 500 begins and receives 505 external information to populate the knowledge database 110. In one embodiment, the method 500 trains 510 a machine learning model (e.g., machine learning algorithms and rules) using historical project data. In one embodiment, the method 500 receives 515 data associated with a project, the data describing one or more characteristics of the project.

In one embodiment, the method 500 determines 520, using the trained machine learning model, one or more metadata tags for the data for classifying the data. In one embodiment, the method 500 matches 525 the classified data to one or more predetermined knowledge insights for the project based on the metadata tags, the one or more predetermined knowledge insights stored in a knowledge database. In one embodiment, the method 500 predicts, 530 using the machine learning model, one or more future conditions of the project based on a state of one or more tasks of the project.

In one embodiment, the method 500 presents 535, on a digital display device, the one or more predetermined knowledge insights, and the method 400 ends. In one embodiment, the method 400 may be performed by a knowledge platform apparatus 104, a project information module 202, a metadata module 204, a linking module 206, a display module 208, a prediction module 302, and/or a knowledge information module 308.

A means for receiving data associated with a project, in various embodiments, may include one or more of a computing device 102, a backend server 110, a knowledge platform apparatus 104, a project information module 202, a processor (e.g., a central processing unit (CPU), a processor core, a field programmable gate array (FPGA) or other programmable logic, an application specific integrated circuit (ASIC), a controller, a microcontroller, and/or another semiconductor integrated circuit device), an HDMI or other electronic display dongle, a hardware appliance or other hardware device, other logic hardware, and/or other executable code stored on a computer readable storage medium. Other embodiments may include similar or equivalent means for receiving data associated with a project.

A means for determining, using machine learning rules and algorithms, one or more metadata tags for the data for classifying the data, in various embodiments, may include one or more of a computing device 102, a backend server 110, a knowledge platform apparatus 104, a metadata module 204, a processor (e.g., a central processing unit (CPU), a processor core, a field programmable gate array (FPGA) or other programmable logic, an application specific integrated circuit (ASIC), a controller, a microcontroller, and/or another semiconductor integrated circuit device), an HDMI or other electronic display dongle, a hardware appliance or other hardware device, other logic hardware, and/or other executable code stored on a computer readable storage medium. Other embodiments may include similar or equivalent means for determining, using machine learning rules and algorithms, one or more metadata tags for the data for classifying the data.

A means for matching the classified data to one or more predetermined knowledge insights for the project based on the metadata tags, in various embodiments, may include one or more of a computing device 102, a backend server 110, a knowledge platform apparatus 104, a linking module 206, a processor (e.g., a central processing unit (CPU), a processor core, a field programmable gate array (FPGA) or other programmable logic, an application specific integrated circuit (ASIC), a controller, a microcontroller, and/or another semiconductor integrated circuit device), an HDMI or other electronic display dongle, a hardware appliance or other hardware device, other logic hardware, and/or other executable code stored on a computer readable storage medium. Other embodiments may include similar or equivalent means for matching the classified data to one or more predetermined knowledge insights for the project based on the metadata tags.

A means for presenting, on a digital display device, the one or more predetermined knowledge insights, in various embodiments, may include one or more of a computing device 102, a backend server 110, a knowledge platform apparatus 104, a display module 208, a processor (e.g., a central processing unit (CPU), a processor core, a field programmable gate array (FPGA) or other programmable logic, an application specific integrated circuit (ASIC), a controller, a microcontroller, and/or another semiconductor integrated circuit device), an HDMI or other electronic display dongle, a hardware appliance or other hardware device, other logic hardware, and/or other executable code stored on a computer readable storage medium. Other embodiments may include similar or equivalent means for presenting, on a digital display device, the one or more predetermined knowledge insights.

Means for performing the other method steps described herein, in various embodiments, may include one or more of a computing device 102, a backend server 110, an project information module 202, a metadata module 204, a linking module 206, a display module 208, a prediction module 302, a sign-on module 304, a notification module 306, a knowledge information module 308, a project scheduling module 310, a change order module 312, a knowledge platform apparatus 104, a network interface, a processor (e.g., a central processing unit (CPU), a processor core, a field programmable gate array (FPGA) or other programmable logic, an application specific integrated circuit (ASIC), a controller, a microcontroller, and/or another semiconductor integrated circuit device), an HDMI or other electronic display dongle, a hardware appliance or other hardware device, other logic hardware, and/or other executable code stored on a computer readable storage medium. Other embodiments may include similar or equivalent means for performing one or more of the method steps described herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
a processor;
a memory that stores code executable by the processor to:
receive data associated with a project, the data describing one or more characteristics of the project;
determine, using machine learning rules and algorithms, one or more metadata tags for the data for classifying the data;
match the classified data to one or more predetermined knowledge insights for the project based on the metadata tags, the one or more predetermined knowledge insights stored in a knowledge database; and
present, on a digital display device, the one or more predetermined knowledge insights.

2. The apparatus of claim 1, wherein the project comprises a construction project composed of a plurality of tasks, the data describing each task of the plurality of tasks such that the tasks are classified according to the metadata and associated with the one or more knowledge insights.

3. The apparatus of claim 2, wherein the code is executable by the processor to predict, using the machine learning rules and algorithms, one or more future conditions of the project based on a state of one or more tasks of the project.

4. The apparatus of claim 3, wherein the code is executable by the processor to identify knowledge insights of the one or more predetermined knowledge insights associated with the predicted one or more future conditions to present based on the state of the one or more tasks of the project.

5. The apparatus of claim 4, wherein the one or more knowledge insights comprise information related to one or more of common mistakes, training materials, lessons learned, definitions, procedures, manuals, or a combination thereof.

6. The apparatus of claim 5, wherein the one or more knowledge insights comprise explanations, schematics, diagrams, blueprints, instructional multimedia, associated codes and laws, or a combination thereof.

7. The apparatus of claim 4, wherein the one or more tasks of the project are associated with one or more users that are engaged to complete the one or more tasks.

8. The apparatus of claim 7, wherein the code is executable by the processor to predict the one or more future conditions of the project and present the corresponding knowledge insights for the one or more future conditions in response to the one or more users signing in to work on the project.

9. The apparatus of claim 8, wherein the code is executable by the processor to present an interface for receiving user log in information from the one or more users and create a contact list for the project for tracking the one or more users that are working on the project.

10. The apparatus of claim 7, wherein the code is executable by the processor to periodically push knowledge insight information to the one or more users based on a status of the one or more tasks that the one or more users are in the process of completing.

11. The apparatus of claim 7, wherein the code is executable by the processor to assign knowledge insight information to one or more users in response to input from a manager and push the knowledge insight information to the one or more assigned users.

12. The apparatus of claim 1, wherein the code is executable by the processor to receive external information for the knowledge database, the external information comprising experiential survey data received from one or more project managers, information scraped from one or more online resources, and information derived from one or more documents.

13. The apparatus of claim 1, wherein the code is executable by the processor to generate a plan and schedule for the project based on the details of the project and the knowledge insights in the knowledge database.

14. The apparatus of claim 1, wherein the code is executable by the processor to receive information for a change order for the project, the information describing one or more characteristics of the change order.

15. The apparatus of claim 13, wherein the code is executable by the processor to determine a phase of the change order, whether the change order is outsourceable, and skills required to complete the change order.

16. The apparatus of claim 14, wherein the code is executable by the processor to generate one or more recommendations for completing the change order, the one or more recommendations based on knowledge insights generated for the change order.

17. The apparatus of claim 15, wherein, in response to the change order being outsourceable, the one or more recommendations comprise a recommendation for one or more professionals that have skills matching the skills required to complete the change order.

18. The apparatus of claim 13, wherein the code is executable by the processor to determine metadata tags for the change order information and add the change order information to the knowledge database for generating one or more knowledge insights in response to the knowledge database not comprising the change order information.

19. A method, comprising:
receiving data associated with a project, the data describing one or more characteristics of the project;
determining, using machine learning rules and algorithms, one or more metadata tags for the data for classifying the data;
matching the classified data to one or more predetermined knowledge insights for the project based on the metadata tags, the one or more predetermined knowledge insights stored in a knowledge database; and
presenting, on a digital display device, the one or more predetermined knowledge insights.

20. An apparatus, comprising:
means for receiving data associated with a project, the data describing one or more characteristics of the project;
means for determining, using machine learning rules and algorithms, one or more metadata tags for the data for classifying the data;
means for matching the classified data to one or more predetermined knowledge insights for the project based on the metadata tags, the one or more predetermined knowledge insights stored in a knowledge database; and
means for presenting, on a digital display device, the one or more predetermined knowledge insights.
